(19) United States
(12) Patent Application Publication
(10) Pub. No.: US 2019/0052406 A1
(43) Pub. Date: Feb. 14, 2019

(54) Transmission For Ultra-Reliable And Low-Latency Communications In Mobile Communications

(71) Applicant: MediaTek Inc., Hsinchu City (TW)

(72) Inventors: Weidong Yang, San Diego, CA (US); Lung-Sheng Tsai, Hsinchu City (TW)

(21) Appl. No.: 16/101,394

(22) Filed: Aug. 11, 2018

Related U.S. Application Data
(60) Provisional application No. 62/544,091, filed on Aug. 11, 2017.

(51) Int. Cl. H04L 1/08; H04L 1/18

(52) U.S. Cl. CPC H04L 1/08; H04L 1/1893

(57) ABSTRACT

Various solutions for blind retransmission for ultra-reliable and low-latency communications (URLLC) with respect to user equipment and network apparatus in mobile communications are described. An apparatus may receive a physical downlink control channel (PDCCH). The apparatus may receive a plurality of physical downlink shared channels (PDSCHs) according to the PDCCH. The apparatus may decode the plurality of PDSCHs according to the PDCCH. The PDCCH may schedule the plurality of PDSCHs.

### CROSS REFERENCE TO RELATED PATENT APPLICATION(S)

The present disclosure is part of a non-provisional application claiming the priority benefit of U.S. Patent Application No. 62/544,091, filed on 11 Aug. 2017, the content of which is incorporated by reference in its entirety.

### TECHNICAL FIELD

The present disclosure is generally related to mobile communications and, more particularly, to blind retransmission for ultra-reliable and low-latency communications (URLLC) with respect to user equipment and network apparatus in mobile communications.

### BACKGROUND

Unless otherwise indicated herein, approaches described in this section are not prior art to the claims listed below and are not admitted as prior art by inclusion in this section.

In New Radio (NR), ultra-reliable and low-latency communications (URLLC) is supported for emerging applications that demands high requirements on end-to-end latency and reliability. A general URLLC reliability requirement for one transmission of a packet is 1-10⁻⁵ for 32 bytes with a user plane latency of 1 ms. For URLLC, the target for user plane latency should be 0.5 ms for uplink and 0.5 ms for downlink.

In downlink transmissions, the user equipment (UE) may need to receive a physical downlink control channel (PDCCH) and/or a physical downlink shared channels (PDSCH) from the network apparatus. In a case that the PDCCH/PDSCH is missed or failed, the UE may need to wait for the retransmission from the network apparatus. The missed reception of the downlink signals may degrade the transmission reliability and may increase the latency for the retransmission.

In uplink transmissions, the same issue may also happen. The UE may need to transmit a physical uplink control channel (PUCCH) and/or a physical uplink shared channels (PUSCH) to the network apparatus. The failed transmission of the uplink signals may also degrade the transmission reliability and may increase the latency at the network side.

Accordingly, how to increase the reliability and reduce the latency for uplink and downlink transmissions is important for URLLC applications. It is needed to provide proper transmission mechanisms for uplink and downlink transmissions.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to blind retransmission for URLLC with respect to user equipment and network apparatus in mobile communications.

In one aspect, a method may involve an apparatus receiving a PDCCH. The method may also involve the apparatus receiving a plurality of PDSCHs according to the PDCCH. The method may further involve the apparatus decoding the plurality of PDSCHs according to the PDCCH. The PDCCH may schedule the plurality of PDSCHs.

In one aspect, a method may involve an apparatus generating one or a plurality of redundancy versions (RVs) corresponding to one or a plurality of PUSCHs with each RV being associated with a respective one of the plurality of PUSCHs. The method may also involve the apparatus transmitting one or a plurality of PUCCHs to at least one network node on one or a plurality of occasions. The method may further involve the apparatus transmitting one or the plurality of PUSCHs to the at least one network node on one or the plurality of occasions. The RVs may be identical or different from each other.

In one aspect, an apparatus may comprise a transceiver capable of wirelessly communicating with a plurality of nodes of a wireless network. The apparatus may also comprise a processor communicatively coupled to the transceiver. The processor may be capable of receiving a PDCCH. The processor may also be capable of receiving a plurality of PDSCHs according to the PDCCH. The processor may further be capable of decoding the plurality of PDSCHs according to the PDCCH. The PDCCH may schedule the plurality of PDSCHs.

In one aspect, an apparatus may comprise a transceiver capable of wirelessly communicating with a plurality of nodes of a wireless network. The apparatus may also comprise a processor communicatively coupled to the transceiver. The processor may be capable of generating one or a plurality of RVs corresponding to one or a plurality of PUSCHs with each RV being associated with a respective one of the plurality of PUSCHs. The processor may also be capable of transmitting, via the transceiver, one or a plurality of PUCCHs to at least one network node on one or a plurality of occasions. The processor may be further capable of transmitting, via the transceiver, one or a plurality of PUSCHs to the at least one network node on one or the plurality of occasions. The RVs may be identical or different from each other.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

FIG. 5 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to blind retransmission for URLLC with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

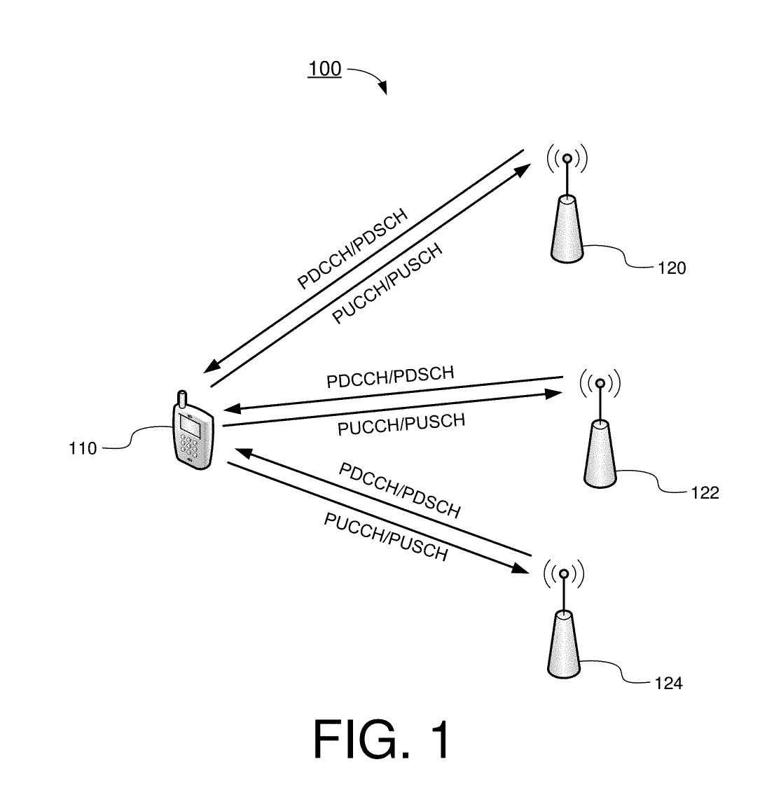

FIG. 1 illustrates an example scenario 100 under schemes in accordance with implementations of the present disclosure. Scenario 100 involves a UE 110 and a plurality of network nodes 120, 122 and 124, which may be a part of a wireless communication network (e.g., an LTE network, an LTE-Advanced network, an LTE-Advanced Pro network, a 5G network, an NR network, an IoT network or an NB-IoT network). Each of the network nodes 120, 122 and 124 may be considered as a transmit/receive point (TRP) of the wireless communication network. The UE may be able to receive downlink signals from at least one of network nodes 120, 122 and 124. The downlink signals may comprise the PDCCH and the PDSCH. The PDCCH may comprise the downlink scheduling information including, for example and without limitation, quasi co-location (QCL) assumptions for antenna ports, modulation and coding scheme (MCS) levels, hybrid automatic repeat request (HARQ) indices, resource allocations, etc. The PDSCH may comprise downlink user data. The UE may also be able to transmit uplink signals to at least one of network nodes 120, 122 and 124. The uplink signals may comprise the PUCCH and the PUSCH. The PUCCH may comprise the uplink control information including, for example and without limitation, scheduling request (SR), hybrid automatic repeat request (HARQ) acknowledgement (AC K)/negative acknowledgement (NACK), channel state information (CSI), etc. The PUSCH may comprise uplink user data and/or channel quality indicator (Cal).

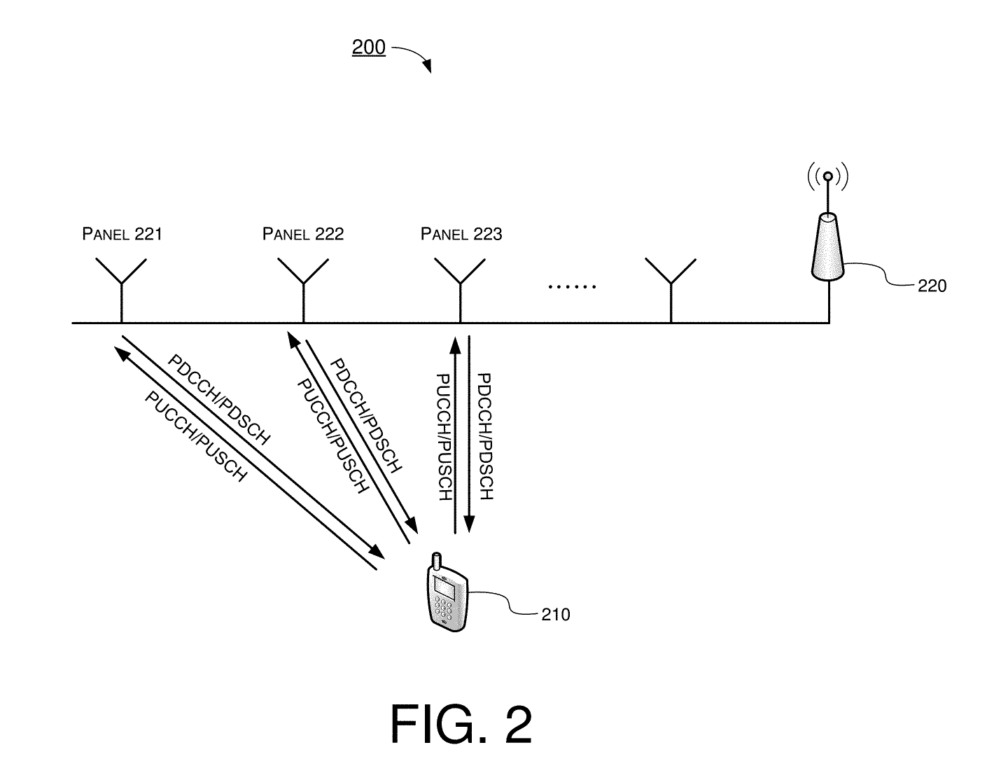

FIG. 2 illustrates an example scenario 200 under schemes in accordance with implementations of the present disclosure. Scenario 200 involves a UE 210 and a network node 220, which may be a part of a wireless communication network (e.g., an LTE network, an LTE-Advanced network, an LTE-Advanced Pro network, a 5G network, an NR network, an IoT network or an NB-IoT network). Network node 220 may comprise a plurality of panels 221, 222, 223, etc. Each panel may comprise an antenna or a group of antennas for transmitting signals to and receiving signals from UE 210. The UE may be able to receive PDCCH and/or PDSCH from each panel of network node 220. The UE may also be able to transmit PUCCH and/or PUSCH to each panel of network node 220.

In NR, URLLC is supported for emerging applications that demands high requirements on end-to-end latency and reliability. In order to meet the high reliability requirements for URLLC, the UE may be configured to receive the blind retransmission from the network side. In legacy HARQ retransmission, the redundancy version (RV) is carried only in the retransmission. Specifically, the UE may be configured to receive a plurality of PDSCHs corresponding to the same higher layer data (e.g., application layer data). The network may use the plurality of PDSCHs to transmit the same higher layer data to the UE. The higher layer data may comprise information bits. The same information bits may be encoded into different versions of encoded bits by the same encoder. In legacy HARQ retransmission, a redundancy version (RV) is used only in the retransmission and it indicates which version of encoded bits to be sent from network to the UE. In this invention, we do not preclude using RVs in initial transmissions. The network may use different PDSCHs to transmit the different versions of encoded bits. Each PDSCHs may comprise a different version of the encoded bits generated according to the same information bits. Thus, multiple copies of the same data (although the encoded bits are different in the copies) may be transmitted diversely among the plurality of PDSCHs to ensure the transmission reliability.

The UE may be configured to receive the PDCCH from one or multiple network nodes. The PDCCH may schedule the plurality of PDSCHs. The UE may be further configured to decode the plurality of PDSCHs according to the PDCCH. Specifically, the PDCCH may indicate the allocated time-frequency resources for the plurality of PDSCHs. The plurality of PDSCHs may be allocated to different time-frequency resources. The different time-frequency resources may be overlapped or non-overlapped. For example, a first PDSCH may be allocated at physical resource blocks (PRBs) 1-10 in a first slot. A second PDSCH may be allocated at PRBs 100-110 in the first slot. Alternatively, a first PDSCH may be allocated at PRBs 1-10 in a first slot. A second PDSCH may be allocated at PRBs 100-110 in a second slot. Furthermore, the plurality of PDSCHs may also be transmitted in different spatial layers. For example, a first network node may transmit the PDSCHs on spatial layers 1-2. A second network node may transmit the PDSCHs on spatial layers 3-4. Alternatively, both the first network node and the second network node may cooperatively transmit the PDSCHs on spatial layers 1-4. The plurality of PDSCHs may also be transmitted by different transmission beams, antennas, or panels of the network node.

The plurality of PDSCHs may comprise encoded bits corresponding to different RVs. The RV may comprise, for example and without limitation, 0, 1, 2 or 3. In a case that each of the PDSCHs comprises encoded bits corresponding to a different RV, different versions of the encoded bits may be received at the UE. A higher coding gain may be achieved. Alternatively, the plurality of PDSCHs may comprise encoded bits corresponding to the same RVs. In a case that each of the PDSCHs comprises an identical RV, repetition versions of the encoded bits may be received at the UE. The UE may be configured to receiver the plurality of PDCCHs/PDSCHs from one network node, from a plurality of panels of one network node, or from a plurality of network nodes.

In downlink control channel design, the PDCCH may need to indicate the scheduling information of the plurality of PDSCHs. In a case that each of the PDSCHs comprises encoded bits corresponding to a different RV, the PDCCH may need to indicate the RV of each of the plurality of PDSCHs. The signaling size of the PDCCH may be increased and large. In a case that the plurality of PDSCHs are transmitted at the same frequency resources, a compact PDCCH without indicating all or part of RVs of the plurality of PDSCHs may be used to inform the UE the resource allocation. The RVs for the plurality of PDSCHs without explicit RV indication are determined by a predetermined rule and/or the RVs indicated for part of the PDSCHs. The signaling size of the PDCCH may be compact. The chase combining may also be easily performed at the UE side. In this invention, we call such a multiple-PDSCH transmission with different RVs without RV indication as ‘blind retransmission’. Alternatively, in a case that a compact PDCCH is used to schedule the plurality of PDSCHs, the PDCCH indicates resource allocations (RAs) corresponding to none, one or more than one of the plurality of PDSCHs, and the RAs for the rest of the plurality of PDSCHs without explicit RA indication are determined by a predetermined rule and the indicated RAs. The predetermined rule may be a frequency hopping rule. The UE may be configured to derive the scheduling information of the plurality of PDSCHs from the compact PDCCH according to the frequency hopping rule or the predetermined rule. The frequency hopping rule or a predetermined rule may be pre-stored at the UE side, or pre-configured by the network node. The signaling size of the compact PDCCH may remain small. In another case when multiple-PDCCH transmission is allowed, the UE may be configured to receive the PDCCHs at different control resources sets (CORESETs) in a mini-slot, different mini-slots, a slot, or different slots. The UE may receive the PDCCHs from one network node or from a plurality of network nodes.

Similarly, the proposed schemes of multiple data transmissions with multiple RVs may also be applied on uplink transmissions. Specifically, the UE may be configured to generate a plurality of PUSCHs corresponding to a plurality of RVs. Each of the PUSCHs may be corresponding to a different RV. The UE may be configured to transmit the plurality of PUSCHs to the at least one network node on a plurality of occasions. The plurality of occasions may comprise a plurality of different sub-bands, a plurality of different time-frequency resources and/or a plurality of different uplink transmission beams. The UE may be configured to transmit plurality of PUSCHs at different time-frequency resources. The different time-frequency resources may be overlapped or non-overlapped. The UE may also be configured to transmit plurality of PUSCHs by different transmission beams, antennas, or panels of the UE.

In uplink control channel design, the UE may be configured to transmit a plurality of PUCCHs indicating identical control information to one or a plurality of network nodes. The plurality of PUCCHs may correspond to the plurality of PUSCHs carrying identical uplink data information at the different occasions. The plurality of PUSCHs may be corresponding to different RVs of encoded bits derived from the uplink data information. The UE may be configured to transmit the PUCCHs at different symbols in a mini-slot, different mini-slots, a slot, or different slots. In order to transmit the plurality of PUCCHs corresponding to a plurality of occasions in a mini-slot or a slot, each of the plurality of PUCCHs may be a short PUCCH. Similarly, the UE may be configured to transmit the plurality of PUCCHs to the at least one network node on a plurality of occasions. The plurality of occasions may comprise a plurality of different sub-bands, a plurality of different time-frequency resources and/or a plurality of different uplink transmission beams.

The plurality of PUCCHs/PUSCHs may be transmitted to one network node or a plurality of network nodes. The plurality of PUCCHs/PUSCHs may be transmitted simultaneously or non-simultaneously. At the network side, the network nodes may be configured to combine the received PUCCHs/PUSCHs and jointly decode the same higher layer data carried by the plurality of PUCCHs/PUSCHs.

### Illustrative Implementations

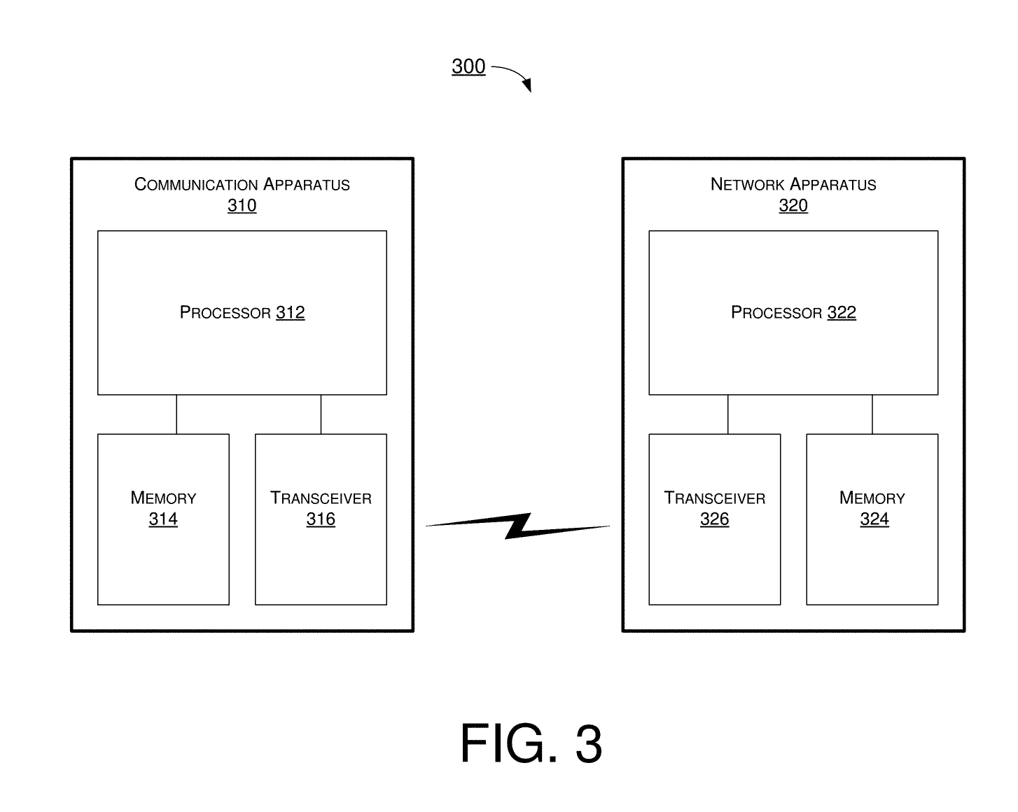

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to blind retransmission for URLLC with respect to user equipment and network apparatus in wireless communications, including scenarios 100 and 200 described above as well as processes 400 and 500 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, or one or more complex-instruction-set-computing (CISC) processors. Communication apparatus 310 may include at least some of those components shown in FIG. 3 such as a processor 312, for example. communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a TRP, a base station, a small cell, a router or a gateway. For instance, network apparatus 320 may be implemented in an eNodeB in an LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, network apparatus 320 may be considered as a TRP of the wireless communication network. Processor 312 may be able to receive, via transceiver 316, downlink signals from network apparatus 320 and a plurality of network apparatus. Processor 312 may be able to receive the PDCCH and the PDSCH from the network apparatus. Processor 312 may be able to transmit, via transceiver 316, uplink signals to network apparatus 320 and a plurality of network apparatus. Processor 312 may be able to transmit the PUCCH and the PUSCH to the network apparatus.

In some implementations, network node 320 may comprise a plurality of panels in transceiver 326. Each panel may comprise an antenna or a group of antennas for transmitting signals to and receiving signals from communication apparatus 310. Processor 312 may be able to receive PDCCH and/or PDSCH from each panel of network node 320. Processor 312 may also be able to transmit PUCCH and/or PUSCH to each panel of network node 320.

In some implementations, processor 312 may be configured to receive the blind retransmission from the network side. Processor 312 may be configured to receive, via transceiver 316, a plurality of PDSCHs corresponding to the same higher layer data (e.g., application layer data). Network apparatus 320 may use the plurality of PDSCHs to transmit the same higher layer data to communication apparatus 310. The higher layer data may comprise information bits. Processor 322 may encode the same information bits into different encoded bits. Processor 322 may use different PDSCHs to transmit the different encoded bits. Each PDSCHs may comprise a different part of the encoded bits which may corresponding to the same information bits.

In some implementations, processor 312 may be configured to receive, via transceiver 316, the PDCCH from one or multiple network apparatus. Network apparatus 320 may use the PDCCH to schedule the plurality of PDSCHs. Processor 312 may be further configured to decode the plurality of PDSCHs according to the PDCCH. Specifically, network apparatus 320 may use the PDCCH to indicate the allocated time-frequency resources for the plurality of PDSCHs. Processor 322 may allocate the plurality of PDSCHs to different time-frequency resources. The different time-frequency resources may be overlapped or non-overlapped. For example, processor 322 may allocate a first PDSCH at PRBs 1-10 in a first slot. Processor 322 may allocate a second PDSCH at PRBs 100-110 in the first slot. Alternatively, processor 322 may allocate a first PDSCH at PRBs 1-10 in a first slot. Processor 322 may allocate a second PDSCH at PRBs 100-110 in a second slot. Furthermore, the network apparatus may transmit the plurality of PDSCHs in different spatial layers. For example, a first network apparatus may transmit the PDSCHs on spatial layers 1-2. A second network apparatus may transmit the PDSCHs on spatial layers 3-4. Alternatively, both the first network apparatus and the second network apparatus may cooperatively transmit the PDSCHs on spatial layers 1-4. The network apparatus may transmit the plurality of PDSCHs by different transmission beams, antennas, or panels.

In some implementations, network apparatus 320 may include different HARQ RVs in the plurality of PDSCHs. In a case that each of the PDSCHs is corresponding to a different RV, processor 312 may be able to receive the different versions of the encoded bits. A higher coding gain may be achieved. Alternatively, network apparatus 320 may include the same RVs in the plurality of PDSCHs. In a case that each of the PDSCHs is corresponding to an identical RV, processor 312 may be able to receive the repetition versions of the encoded bits. Processor 312 may be configured to receiver the plurality of PDCCHs/PDSCHs from one network apparatus, or from a plurality of network apparatus.

In some implementations, network apparatus 320 may use the PDCCH to indicate the scheduling information of the plurality of PDSCHs. In a case that each of the PDSCHs is corresponding to a different RV, processor 322 may use the PDCCH to indicate the RV of each of the plurality of PDSCHs. The signaling size of the PDCCH may be increased and large. In a case that a predetermined rule is used to imply the RVs corresponding to plurality of PDSCHs are the same, processor 322 may use a compact PDCCH without indicating RVs of the plurality of PDSCHs to inform communication apparatus 310 the resource allocation. The signaling size of the PDCCH may be compact. Processor 312 may perform the chase combining easily.

In some implementations, in a case that a compact PDCCH is used to schedule the plurality of PDSCHs, the PDCCH may indicate resource allocations (RAs) corresponding to none, one or more than one of the plurality of PDSCHs, and the RAs for a remaining portion of the plurality of PDSCHs without explicit RA indication are determined by a predetermined rule and the indicated RAs. In some implementations, processor 312 may be configured to receive the plurality of PDSCHs according to a frequency hopping rule or a predetermined rule. Processor 312 may be configured to derive the scheduling information of the plurality of PDSCHs from the compact PDCCH according to the frequency hopping rule or the predetermined rule. The frequency hopping rule or a predetermined rule may be pre-stored in the memory 314 of communication apparatus 310, or pre-configured by network apparatus 320. The signaling size of the compact PDCCH may remain small. Processor 312 may be configured to receive the PDCCHs at different CORESETs in a mini-slot, different mini-slots, a slot, or different slots. Processor 312 may receive the PDCCHs from one network apparatus or from a plurality of network apparatus.

In some implementations, processor 312 may be configured to generate a plurality of PUSCHs consisting of encoded bits corresponding to a plurality of RVs. Each of the PUSCHs may be corresponding to a different RV. Processor 312 may be configured to transmit, via transceiver 316, the plurality of PUSCHs to the at least one network apparatus on a plurality of occasions. The plurality of occasions may comprise a plurality of different sub-bands, a plurality of different time-frequency resources and/or a plurality of different uplink transmission beams. Processor 312 may be configured to transmit plurality of PUSCHs at different time-frequency resources. The different time-frequency resources may be overlapped or non-overlapped. Processor 312 may also be configured to transmit plurality of PUSCHs by different transmission beams, antennas, or panels of transceiver 316.

In some implementations, processor 312 may be configured to transmit a plurality of PUCCHs to one or a plurality of network apparatus. The plurality of PUCCHs may be transmitted at the different occasions. Processor 312 may be configured to transmit the PUCCHs at different symbols in a mini-slot, different mini-slots, a slot, or different slots. In order to transmit the plurality of PUCCHs corresponding to a plurality of occasions in a mini-slot or a slot, each of the plurality of PUCCHs may be a short PUCCH. Similarly, processor 312 may be configured to transmit the plurality of PUCCHs to the at least one network apparatus on a plurality of occasions. The plurality of occasions may comprise a plurality of different sub-bands, a plurality of different time-frequency resources and/or a plurality of different uplink transmission beams.

In some implementations, processor 312 may transmit, via transceiver 316, the plurality of PUCCHs/PUSCHs to one network apparatus or a plurality of network apparatus. Processor 312 may transmit the plurality of PUCCHs/PUSCHs simultaneously or non-simultaneously. At the network side, the network apparatus may be configured to combine the received PUCCHs/PUSCHs and jointly decode the same higher layer data carried by the plurality of PUCCHs/PUSCHs.

### Illustrative Processes

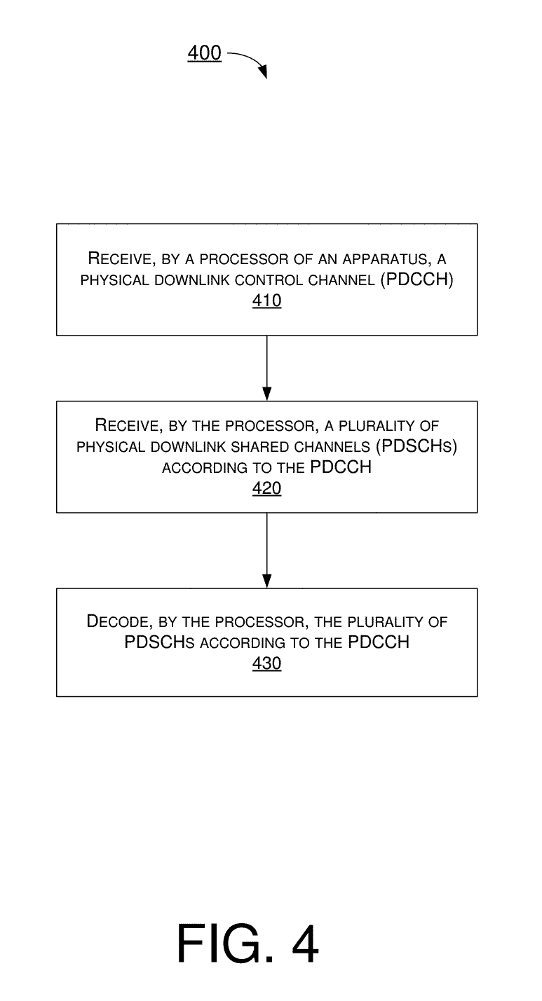

FIG. 4 illustrates an example process 400 in accordance with an implementation of the present disclosure. Process 400 may be an example implementation of scenarios 100 and 200, whether partially or completely, with respect to blind retransmission for URLLC in accordance with the present disclosure. Process 400 may represent an aspect of implementation of features of communication apparatus 310. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of communication apparatus 310 receiving a PDCCH. Process 400 may proceed from 410 to 420.

At 420, process 400 may involve processor 312 receiving a plurality of PDSCHs according to the PDCCH. Process 400 may proceed from 420 to 430.

At 430, process 400 may involve processor 312 decoding the plurality of PDSCHs according to the PDCCH. The PDCCH may schedule the plurality of PDSCHs.

In some implementations, each of the PDSCHs may comprise a respective version of encoded bits corresponding to a different RV.

In some implementations, each of the PDSCHs may comprise encoded bits corresponding to an identical RV.

In some implementations, the PDCCH may indicate a plurality of RVs corresponding to none, one or more than one of the plurality of PDSCHs respectively. The RVs for a remaining portion of the plurality of PDSCHs without explicit RV indication may be determined by a predetermined rule and the indicated RVs.

In some implementations, the PDCCH may indicate resource allocations (RAs) corresponding to none, one or more than one of the plurality of PDSCHs. The RAs for a remaining portion of the plurality of PDSCHs without explicit RA indication may be determined by a predetermined rule and the indicated RAs.

In some implementations, process 400 may involve processor 312 receiving the plurality of PDSCHs according to a frequency hopping rule, or a predetermined rule.

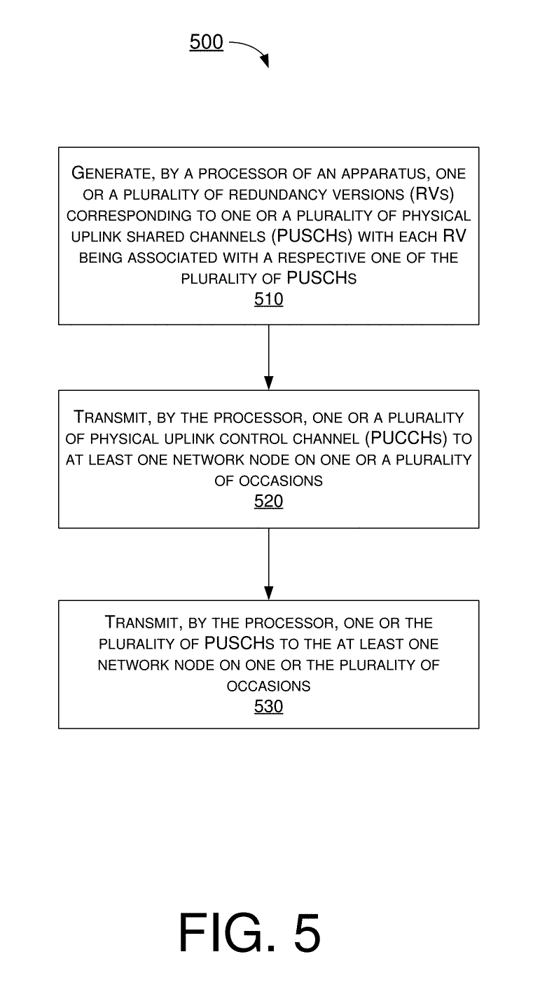

FIG. 5 illustrates an example process 500 in accordance with an implementation of the present disclosure. Process 500 may be an example implementation of scenarios 100 and 200, whether partially or completely, with respect to blind retransmission for URLLC in accordance with the present disclosure. Process 500 may represent an aspect of implementation of features of communication apparatus 310. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 310 or any suitable UE or machine type devices. Solely for illustrative purposes and without limitation, process 500 is described below in the context of communication apparatus 310. Process 500 may begin at block 510.

At 510, process 500 may involve processor 312 of communication apparatus 310 generating one or a plurality of RVs corresponding to one or a plurality of PUSCHs with each RV being associated with a respective one of the plurality of PUSCHs. Process 500 may proceed from 510 to 520.

At 520, process 500 may involve processor 312 transmitting one or a plurality of PUCCHs to at least one network node on one or a plurality of occasions. Process 500 may proceed from 520 to 530.

At 530, process 500 may involve processor 312 transmitting, by the processor, one or the plurality of PUSCHs to the at least one network node on one or the plurality of occasions. Each of the PUSCHs may comprise encoded bits corresponding to a different RV. Additionally, or alternatively, the RVs may be identical or different form each other.

In some implementations, the plurality of occasions may comprise a plurality of different time-frequency resources.

In some implementations, the plurality of occasions may comprise a plurality of different uplink transmission beams.

In some implementations, the plurality of occasions may be in a slot, or in a plurality of slots.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a physical downlink control channel (PDCCH);
receiving, by the processor, a plurality of physical downlink shared channels (PDSCHs) according to the PDCCH; and
decoding, by the processor, the plurality of PDSCHs according to the PDCCH,
wherein the PDCCH schedules the plurality of PDSCHs.

2. The method of claim 1, wherein each of the PDSCHs comprises a respective version of encoded bits corresponding to a different redundancy version (RV).

3. The method of claim 1, wherein each of the PDSCHs comprises encoded bits corresponding to an identical redundancy version (RV).

4. The method of claim 1, wherein the PDCCH indicates a plurality of redundancy versions (RVs) corresponding to the plurality of PDSCHs respectively.

5. The method of claim 1, wherein the PDCCH indicates redundancy versions (RVs) corresponding to none, one or more than one of the plurality of PDSCHs, and wherein the RVs for a remaining portion of the plurality of PDSCHs without explicit RV indication are determined by a predetermined rule and the indicated RVs.

6. The method of claim 1, wherein the PDCCH indicates resource allocations (RAs) corresponding to none, one or more than one of the plurality of PDSCHs, and wherein the RAs for a remaining portion of the plurality of PDSCHs without explicit RA indication are determined by a predetermined rule and the indicated RAs.

7. A method, comprising:
generating, by a processor of an apparatus, one or a plurality of redundancy versions (RVs) corresponding to one or a plurality of physical uplink shared channels (PUSCHs) with each RV being associated with a respective one of the plurality of PUSCHs;
transmitting, by the processor, one or a plurality of physical uplink control channel (PUCCHs) to at least one network node on one or a plurality of occasions; and
transmitting, by the processor, one or the plurality of PUSCHs to the at least one network node on one or the plurality of occasions,
wherein the RVs are either identical or different from each other.

8. The method of claim 7, wherein the plurality of occasions comprise a plurality of different time-frequency resources.

9. The method of claim 7, wherein the plurality of occasions comprise a plurality of different uplink transmission beams.

10. The method of claim 7, wherein the plurality of occasions are in a slot, or in a plurality of slots.

11. An apparatus, comprising:
a transceiver capable of wirelessly communicating with a plurality of nodes of a wireless network; and
a processor communicatively coupled to the transceiver, the processor capable of:
receiving, via the transceiver, a physical downlink control channel (PDCCH);
receiving, via the transceiver, a plurality of physical downlink shared channels (PDSCHs) according to the PDCCH; and
decoding the plurality of PDSCHs according to the PDCCH,
wherein the PDCCH schedules the plurality of PDSCHs.

12. The apparatus of claim 11, wherein each of the PDSCHs comprises a respective version of encoded bits corresponding to a different redundancy version (RV).

13. The apparatus of claim 11, wherein each of the PDSCHs comprises encoded bits corresponding to an identical redundancy version (RV).

14. The apparatus of claim 11, wherein the PDCCH indicates all or part of, or none of a plurality of redundancy versions (RVs) corresponding to the plurality of PDSCHs respectively.

15. The apparatus of claim 11, wherein the PDCCH indicates none, part of, or all of a plurality of time-frequency resource allocations (RAs) corresponding to the plurality of PDSCHs respectively.

16. The apparatus of claim 15, wherein the processor is further capable of:
receiving, via the transceiver, the plurality of PDSCHs according to a frequency hopping rule, or a predetermined rule.

17. An apparatus, comprising:
a transceiver capable of wirelessly communicating with a plurality of nodes of a wireless network; and
a processor communicatively coupled to the transceiver, the processor capable of:
generating one or a plurality of redundancy versions (RVs) corresponding to one or a plurality of physical uplink shared channels (PUSCHs) with each RV being associated with a respective one of the plurality of PUSCHs;
transmitting, via the transceiver, one or a plurality of physical uplink control channel (PUCCHs) to at least one network node on one or a plurality of occasions; and
transmitting, via the transceiver, one or a plurality of physical uplink shared channels (PUSCHs) to the at least one network node on one or the plurality of occasions,
wherein the RVs are either identical or different from each other.

18. The apparatus of claim 17, wherein the plurality of occasions comprise a plurality of different time-frequency resources.

19. The apparatus of claim 17, wherein the plurality of occasions comprise a plurality of different uplink transmission beams.

20. The apparatus of claim 17, wherein the plurality of occasions are in a slot, or in a plurality of slots.
